(19) United States
(12) Patent Application Publication
(10) Pub. No.: US 2008/0264344 A1
(43) Pub. Date: Oct. 30, 2008

(54) FORAGING DEVICE

(75) Inventors: Brian WOOD, Chagrin Falls, OH (US); George WHITE, Chagrin Falls, OH (US)

Correspondence Address: CALFEE HALTER & GRISWOLD, LLP, 800 SUPERIOR AVENUE, SUITE 1400, CLEVELAND, OH, 44114, US

(73) Assignee: FIBERCORE LLC, Cleveland, OH (US)

(21) Appl. No.: 12/108,990

(22) Filed: Apr. 24, 2008

Related U.S. Application Data
(60) Provisional application No. 60/913,587, filed on Apr. 24, 2007.

(51) Int. Cl. A01K 15/02; A01K 1/10; A01K 39/01

(52) U.S. Cl. 119/51.01; 119/712

(57) ABSTRACT

A device and method that encourages and develops the natural, instinctive foraging behavior in captive animals and birds. The device includes a container having an internal chamber or a recess and one or more openings or access points that allow a bird or small animal to access the chamber. At least one foraging material is disposed within the chamber. Food, treats, or toys for the bird or small animal may also be disposed in the chamber, adjacent or intermixed with the foraging material.

### RELATED APPLICATIONS SECTION

This application claims the benefit of U.S. provisional patent application Ser. No. 60/913,587 for FORAGING DEVICE filed Apr. 24, 2007, the entire disclosure of which is fully incorporated herein by reference.

### BACKGROUND

In the wild, birds and small animals spend a majority of their time foraging (i.e. looking for food). Foraging is a natural, healthy, instinctive behavior for wild birds and small animals. Captive birds and small animals, such as pet birds or laboratory animals, however, are often fed from a food bowl or dish. Thus, captive birds and small animals may not be exposed to an environment in which foraging for food is encouraged or necessary. Studies, however, have shown that foraging can reduce abnormal behaviors in captive birds and small animals and that once captive birds and small animals learn to forage for a meal, they actually prefer to continue to forage for a meal versus eating from a bowl.

### SUMMARY OF THE INVENTION

The present application discloses a device and method that encourages and develops the natural, instinctive foraging behavior in captive animals and birds. The device may encourage birds and small animals to play with a foraging material and/or search through the material to find food, treats, or toys that they cannot see, which results in increased activity and improved health and quality of life for the captive bird or animal. In one embodiment, the device includes a container having an internal chamber or a recess and one or more openings or access points that allow a bird or small animal to access the chamber. At least one foraging material is at least partially disposed within the chamber. Food, treats, or toys for the bird or small animal may also be at least partially disposed in the chamber, adjacent or intermixed with the foraging material. Thus, in order to get at the food, treats or toys, the bird or small animal searches through the foraging material to locate and find the food.

The present application also discloses a device and method for stimulating increased activity corresponding to feeding captive birds and small animals. In one embodiment, the device may include a container for housing at least one foraging material and, optionally, food. The container may be made of a material that the bird or small animal may tear, deform, or otherwise manipulate while gaining access to the at least one foraging material and food disposed within the container.

Further aspects and concepts will become apparent to those skilled in the art after considering the following description in conjunction with the accompanying drawings.

### BRIEF DESCRIPTION OF DRAWINGS

In the accompanying drawing, which are incorporated in and constitute a part of the specification, embodiments of the invention are illustrated, which, together with a general description of the invention given above, and the detailed description given below, serve to exemplify embodiments of the invention.

FIG. 1 is a perspective view of an exemplary embodiment of a foraging device as disclosed in the present application;

FIG. 2 is a top view of the foraging device of FIG. 1 illustrated in an laid-open configuration; and

FIG. 3 is a side cross-section of the foraging device of FIG. 1.

### DETAILED DESCRIPTION

The present application discloses a device that encourages and develops the foraging skill in captive animals, such as birds and small animals. While the exemplary embodiments illustrated and described herein are presented in the context of a free-standing, box-shaped, cardboard container that houses a foraging material composed primarily of folded paper strips and includes a plurality of access openings, those skilled in the art will readily appreciate that the device may be used and configured in a variety of ways. For example, the container may be shaped in a variety of ways, such as spherical, cubical, conical, or any other suitable shape and the number of, size of, shape of, and location of the access openings may different among different embodiments of the device. In addition, the container may be made from any suitable material for use with birds and small animals, such as, for example, but not limited to, plastic, wood, acrylic, or paper-based materials, such as paperboard or pulp board. Furthermore, the container may be used separately as a free-standing device or combined with another structure(s) or device(s) to encourage or enhance foraging. For example, the container may be adapted to attach to or be housed within some other structure, such as a cage, another container, or a forage tree. Still further, the foraging material may be made from any suitable material for use with birds and small animals and may be shaped in any manner suitable for encouraging foraging. The foraging device may include one type of foraging material or multiple types of foraging material, such as different shapes, sizes, or materials.

While various aspects and concepts of the invention are described and illustrated herein as embodied in combination in the exemplary embodiments, these various aspects and concepts may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or identified herein as conventional or standard or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated. The embodiments described in the summary and throughout the specification are not intended to limit the meaning or scope of the claims in any way. The terms used in the claims have all of their full ordinary meaning.

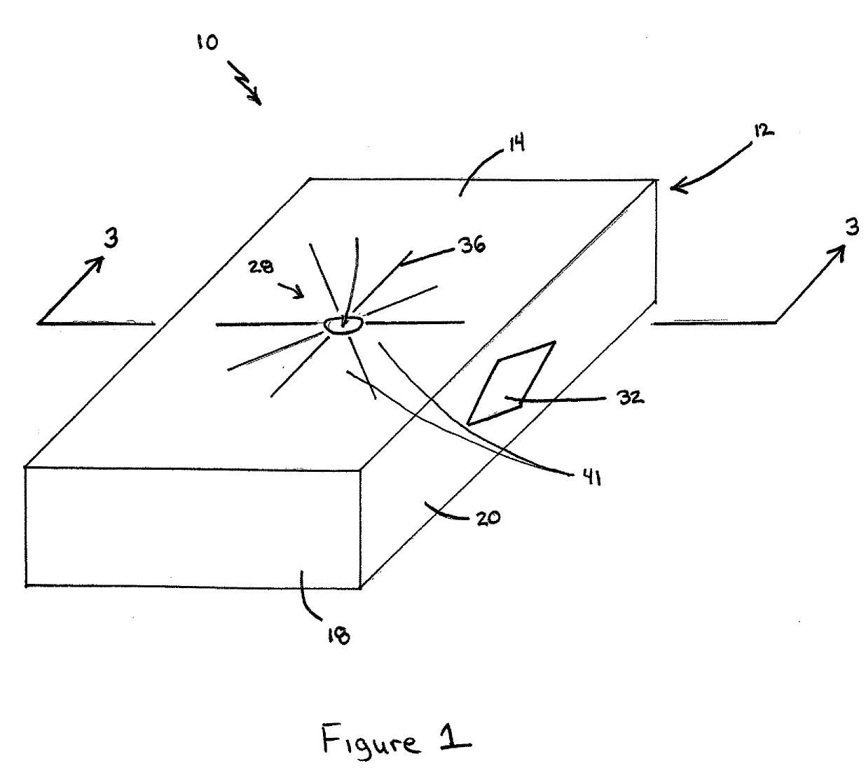

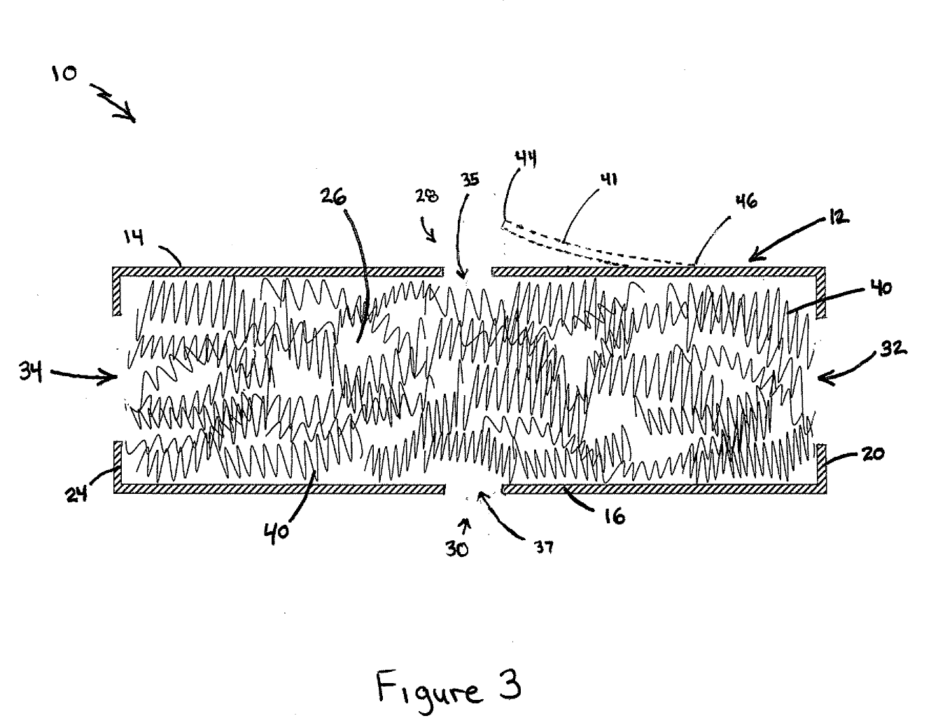

FIGS. 1-3 illustrate an exemplary embodiment of a foraging device 10. The foraging device 10 includes a container 12. The container 12 may be configured in a variety of ways such as for example, but not limited to, different shapes, sizes, and materials. Any structure capable of housing a foraging material, and optionally food, treats, or one or more toys, to encourage foraging by captive birds or small animals may be used. In the depicted embodiment, the container 12 is a box-shaped structure having a top wall 14 that is generally parallel to a bottom wall 16. The top wall 14 and the bottom wall 16 are connected by a first side wall 18, a second side wall 20, a third side wall 22, and a fourth side wall 24 to define an internal chamber 26 (see FIG. 3). Each of the walls may include one or more openings that allow access to the internal chamber 26. In the depicted embodiment, the top wall 14 includes a first opening 28, the bottom wall 16 includes a second opening 30, the second side wall 20 includes a third opening 32, and the fourth side wall 24 includes a fourth opening 34. In another embodiment, the container may have one or more of the walls missing or removed, such as the top wall, for example, to allow access to the chamber or recess 26. In another embodiment, the container may include less than or more than four openings and may include multiple openings per side, wall, or section. For example, in one embodiment, the container only includes a single opening on the top wall for allowing access into the chamber.

The openings 28, 30, 32, 34, may be configured in a variety of ways. Any opening may be used that allows access to the internal chamber 26 while resisting the removal of or the exiting of select foraging material from within the chamber. Thus, the size of, the shape of, the number of, and the location of the openings may vary for different embodiments of the device 10 and different embodiments of the foraging material placed within the chamber 26. In the depicted embodiment, the first opening 28 includes a first generally circular aperture 35 and a plurality of slits 36 and the second opening 30 includes a second generally circular aperture 37 and a plurality of slits 38 oriented to create a first set of flaps 41 and a second set of flaps 43, respectively between the slits. In the depicted embodiment, the slits 36, 38 extend generally radially outward from the generally circular apertures 35, 37, though other orientations are possible. The first set of flaps 41 between the slits 36 have a first free end 44 and a second anchored or hinged end 46 that allows the portion to be readily moved, deflected, bent, torn, or otherwise manipulated by the bird or small animal while it is accessing the internal chamber 26 (see FIG. 3). In one embodiment, the circular apertures 35, 37 are in the range of about ⅛ inch to about ½ inch in diameter and the slits 36, 38 are in the range of about 1 inch to about 2 inches long, depending on the size of the wall or face of the container on which the first opening 28 and the second opening 30 are located. In another embodiment, one or more slits 36, 38 comprise one or more perforated sections, such that the free end a flap is secured to an adjacent flap or wall portion until a force from an external source, such as a bird or small animal, tears the perforated section to free the end of the flap.

In the depicted embodiment, the third opening 32 in the second side wall 20 and the fourth opening 34 in the fourth side wall 24 are generally shaped as a rhombus, diamond, or other parallelogram with dimensions within the range of around 1 inch to around 2 inches for the longer diagonal and about ¼ inch to about ¾ inch for the shorter diagonal. As discussed further below, the size and configuration of the openings may be a function of the type of foraging material placed within the container.

The container 12 may be constructed of a variety of materials that are suitable for use with birds and small animals. As a non-limiting example, plastic, wood, acrylic, or any paper-based material, such as cardboard, paperboard, chipboard or pulpboard, may be used for the container. In the depicted embodiment, the container 12 is constructed from 18 point bending chipboard, which provides sufficient rigidity and support for the container to be free-standing or mounted and for the container to hold the foraging material and, optionally, food, while also allowing many captive birds (such as parakeets, cockatiels, conures, parrots, etc.) and small animals (mice, hamsters, rats, etc.) to tear, chew, or otherwise deform or destroy the container as part of the foraging activity.

The material used to construct the container 12 may be specifically selected and the thickness of the container walls may be specifically configured to allow a select type of bird or small animal to tear, chew, or otherwise deform or destroy the container. Thus, for larger animals, such as primates or larger birds, a sturdier material may be selected, such as a thicker chipboard (e.g. 21 point bending chipboard) or some other material. In one embodiment, the material used to construct the container 12 has a thickness in the range of about 0.16 inches to about 0.40 inches. The container 12, however, may be constructed of a material that resists being readily destroyed or chewed apart by the captive bird or animal, such as wood, plastic or acrylic, for example.

The container 12 may also be constructed in a variety of shapes and sizes. In the depicted embodiment, the container 12 is a box-like structure with dimensions in the range of about 3½ to about 6½ inches in length by about 3½ to about 1 inch in width by about 2 to 1 inch in height. Other embodiments of the device, however, may have different dimensions and/or configured in a different shape. For example, the container 12, may be shaped as a cylinder, a pyramid, a cube, or any other suitable shape. In addition, the device 10 may be configured differently for different animals. For a large bird or primate, the device 10 may be larger, have thicker walls, and have different size and shaped openings than for a small bird or mouse, for example.

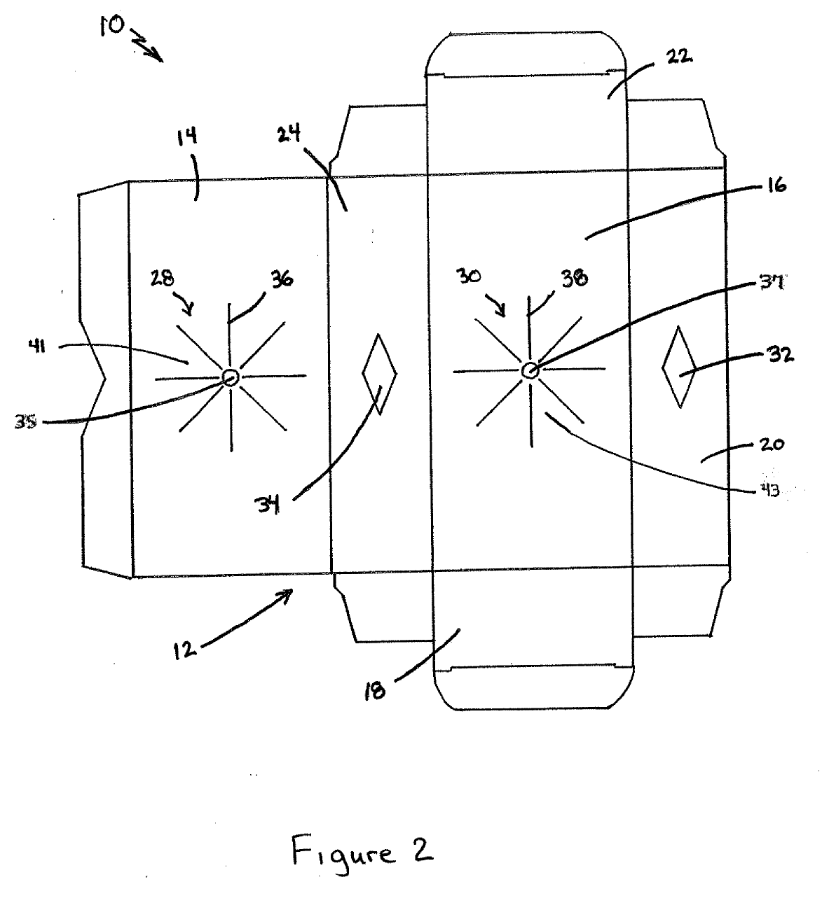

As illustrated in FIG. 2, the container 12 may be constructed as a single sheet of material that is configured to be folded or otherwise arranged to form the container 12 with the internal chamber 26. One of skill in the art, however, will appreciate that the container 12 may be constructed from multiple parts or components. One or more walls may include tabs 42 along select edges that interact with other walls when the container 12 is folded or otherwise arranged to an assembled configuration. The tabs 42 aid in maintaining the container 12 in the assembled configuration.

Referring to FIG. 3, the device 10 includes at least one foraging material 40 disposed at least partially within the internal chamber 26. The foraging material 40 may be configured in a variety of ways. Any bird-safe, small animal-safe material that can stimulate increased activity in captive birds and small animals, corresponding to feeding or foraging, and, optionally may be combined with food, treats, or toy(s) within the chamber 26 may be used. In the depicted embodiment, the foraging material 40 is configured as a plurality of separate, folded or rolled, paper-based pieces that are bird-safe, absorbent, compostable, and dust free. In particular, as illustrated in FIG. 3, the foraging material 40 is realized as a plurality of crinkled or bellows-folded paper strips. The paper strips, before being crinkled or folded are within the range of about ⅛ inch to about ¼ inch wide and about 3 inches to about 6 inches long and are crinkled or bellows-folded. A suitable foraging material has been found to be the Eco-Nest and Forage® nesting material, which is available from Fibercore, LLC. The device 10, however, may include multiple types, sizes, or shapes of foraging material. For example, in one embodiment of the device 10, a foraging material comprising a plurality of separate, folded or rolled, paper-based pieces is combined within the chamber 26 with one or more other foraging materials such as but not limited to a paper-based, cotton, and/or leather materials.

In operation, the at least one foraging material 40 is disposed within the chamber 26. The container and foraging material may be supplied pre-assembled to the end user, may be supplied with a pre-formed container separate from the foraging material, or may be supplied with the container as a single unfolded sheet of material which the end user must fold to form that container and insert the foraging material. The foraging material 40 is generally randomly arranged in the chamber such that a first, a second, and a third piece of foraging material of the plurality of pieces are arranged in a first, a second, and a third different orientation. The amount of foraging material 40 disposed within the chamber 26 may be sufficient to substantially fill the entire chamber. In addition, food or treats, such as seed, pellets, meal, millet spray or other appropriate feed or treat (not shown) and/or a toy(s), such as bell(s), ball(s), or other appropriate toy, may optionally be intermixed with the at least one material 40. For example, a wall, such as top wall 14, first side wall 18, or third side wall 22 may be unfolded allowing the end user access to the chamber to add food.

When assembled, to gain access to the foraging material and/or find the food, the bird or small animal may access the chamber 26 via any of the openings 28, 30, 32, 34. Since the container 12 may be made of a material that the bird or small animal may chew, tear, or deform in some other manner, the bird or small animal may alter the openings 28, 30, 32, 34 or create additional openings to gain further access to the chamber 26. Once access to the chamber 26 is achieved, the bird or small animal may, for example, play with the foraging material 40 and/or search through the foraging material to find the food. The amount and configuration of the foraging material 40 and the size and location of the openings 28, 30, 32, 34 in the container 12 may be selected to provide resistance to the bird or small animal when the bird or small animal attempts to remove the foraging material from the container. Thus, the openings can serve as a means in which the captive bird or small animal can see the foraging material to create interest but are not so large as to allow the foraging material to readily spill from the container. In addition, the openings can serve as a means of resisting the removal of the foraging material by the bird or small animal in order to create additional work to stimulate healthy activity. Therefore, the shape of the opening and the shape of the foraging material as well as the ratio between the size of the opening versus the size of the foraging material can be selected to provide one or more of these functions.

The invention has been described with reference to the preferred embodiments. Modification and alterations will occur to others upon a reading and understanding of this specification. It is intended to include all such modifications and alterations insofar as they come within the scope of the appended claims or the equivalents thereof. The embodiments described in the summary and throughout the specification are not intended to limit the meaning or scope of the claims in any way. The terms used in the claims have all of their full ordinary meaning.

1. A foraging device, comprising:
a container including at least one wall that defines an internal chamber;
at least one opening in the at least one wall that provides access to the chamber;
at least one foraging material disposed within the chamber, the foraging material comprising a plurality of individual pieces, wherein a first, a second, and a third individual piece of the plurality of individual pieces are arranged in a first, a second, and a third different orientation.

2. The foraging device of claim 1 wherein the plurality of individual pieces comprise rolled or bellows-folded, paper strips.

3. The foraging device of claim 2 wherein the plurality of individual pieces substantially fill the entire chamber.

4. The foraging device of claim 1 wherein the container is formed by a single piece of folded material.

5. The foraging device of claim 1 wherein the at least one opening comprising a generally circular opening and a plurality of slits in the at least one wall oriented to create a plurality of flaps.

6. The foraging device of claim 5 wherein the flaps include a free end adjacent the generally circular opening and an anchored end, opposite the free end such that the flaps are bendable.

7. The foraging device of claim 1 wherein the container is constructed of bendable chipboard.

8. The foraging device of claim 1 wherein an individual piece of un folded foraging material is within the range of about ⅛ inch to about ¼ inch wide and about 3 inches to about 6 inches long.

9. The foraging device of claim 8 wherein the area of the at least one opening is around 0.125 square inches to around 0.75 square inches.

10. A method for encouraging and developing the natural, instinctive foraging behavior in captive animals and birds, comprising:
providing a container having at least one wall that defines an internal chamber and an opening in the at least one wall that provides access to the internal chamber;
placing a foraging material that comprising a plurality of individual paper-based pieces randomly within the chamber; and
placing food for the captive animal or bird within the chamber intermixed with the at least one foraging material.

11. The method of claim 8 wherein the step of providing a container comprises folding a single sheet of paper-based material having at least six faces to form the container.

12. The method of claim 11 wherein the step of placing food within the chamber includes unfolding a wall of the container and inserting the food into the foraging material in the chamber.

13. The method of claim 8 wherein the opening comprising a generally circular opening and a plurality of radially extending slits, and wherein the portions of the wall between the radially extending slits include a free end adjacent the generally circular opening and a hinged end, opposite the free end such that the portions of the wall are bendable.

14. A foraging device for a bird or small animal, comprising:
a generally rectangular container formed by a single sheet of a paper-based material, the container including a top wall, a bottom wall, a first side wall, a second side wall, a third side wall, and a fourth side wall that define an internal chamber, the top wall having first opening, the bottom wall having a second opening, the first side wall having a third opening, and the third side wall having a fourth opening, which provide access to the internal chamber; the first opening and the second opening comprising a generally circular aperture and a plurality of radially extending slits that form flaps therebetween, wherein the flaps include a free end adjacent the generally circular opening and an anchored end, opposite the free end such that the flaps are bendable; and
a plurality of rolled or bellows-folded, individual paper strips randomly arranged within the chamber such that the paper strips substantially fill the entire chamber.

15. The foraging device of claim 14 wherein an individual piece of un folded foraging material is within the range of about ⅛ inch to about ¼ inch wide and about 3 inches to about 6 inches long.

16. The foraging device of claim 15 wherein the area of the at least one opening is around 0.125 square inches to around 0.75 square inches.

17. A kit for supplying a foraging device for a bird or small animal, comprising:
a sheet of material adapted to form a closed box having at least six faces, wherein at least one of the six faces includes a pre-cut opening;
foraging material comprising a plurality of individual paper-based pieces; and
a set of instructions comprising adding food to the closed box.

18. The kit of claim 15 wherein the sheet of material is pre-assembled into a closed box that defines an inner chamber and the foraging material is disposed within the chamber.

19. The kit of claim 18 wherein the set of instructions further comprising unfolding at least one wall of the closed box to insert food into the inner chamber.
